(19) United States
(12) Patent Application Publication
(10) Pub. No.: US 2017/0066996 A1
(43) Pub. Date: Mar. 9, 2017

(54) FILMS AND UNIT DOSE ARTICLES COMPRISING AVERSIVE AGENTS, AND USES AND METHODS RELATED THERETO

(71) Applicant: The Procter & Gamble Company, Cincinnati, OH (US)

(72) Inventors: Regine LABEQUE, Neder-over-Heembeek (BE); Philip Frank SOUTER, Northumberland (GB); Miguel BRANDT-SANZ, Tervuren (BE); David Xavante CUMMING, Brussels (BE); Florence Catherine COURCHAY, Brussels (BE); Aram Armand DEDEYAN, Newcastle-upon-Tyne (GB)

(21) Appl. No.: 15/252,270

(22) Filed: Aug. 31, 2016

(30) Foreign Application Priority Data
Sep. 4, 2015 (EP) 15183841.4

(51) Int. Cl. C11D 3/37; C11D 11/00; B65B 3/00; C11D 17/04; C11D 3/32; B65D 65/46; C11D 1/22; C11D 3/30

(52) U.S. Cl. CPC C11D 3/3753; C11D 1/22; C11D 11/0017; C11D 3/30; C11D 17/043; C11D 17/045; C11D 11/0023; C11D 3/32; B65D 65/46; B65B 3/00

(57) ABSTRACT

Films having an aversive agent, where the films are characterized by a certain average thickness. Unit dose articles including such films. Methods of making and using such films and unit dose articles.

### FIELD OF THE INVENTION

The present disclosure relates to films comprising an aversive agent, where the films have a certain thickness. The present disclosure further relates to unit dose articles comprising such films. The present disclosure further relates to methods of making and using such films and unit dose articles.

### BACKGROUND OF THE INVENTION

Water-soluble unit dose articles are becoming increasingly popular with consumers as they offer effective and efficient means of dosing appropriate levels of detergent or cleaning compositions to the wash. The water-soluble unit dose articles typically come in the form of small pouches made of water-soluble films, where the pouches contain concentrated detergent or cleaning compositions. Such films must be selected for a variety of processing and performance criteria, such as thermoformability, sealability, and dissolution properties. A common commercially available film is a polyvinyl alcohol film called M8630 film that has a thickness of approximately 76 microns, available from MonoSol, LLC (Merrilville, Ind., USA).

Aversive agents can be added to water-soluble unit dose article to reduce likelihood of accidental ingestion. Such aversive agents could be substances that provide a bitter taste to the unit dose article and so elicit an instinctive impulse to spit the unit dose article out of the mouth.

One method of providing the unit dose article with an aversive agent is to formulate it within the water-soluble film itself. However, when such pouches contain a liquid composition, the aversive agent tends to migrate out of the film and into the liquid composition, which may thereby reduce the effectiveness of the aversive agent.

There is a need, therefore, for films and unit dose articles comprising such films that provide improved combinations of aversive properties, dissolution profiles, and the like.

### SUMMARY OF THE INVENTION

The present disclosure relates to films having an aversive agent, where the films have a certain thickness, and to unit dose articles, such as pouches, that include such films, as well as related methods and uses.

More specifically, the present disclosure relates to a water-soluble or water-dispersible film, where the film includes an aversive agent, and where the film is characterized by an average thickness of from 80 um to about 200 um.

The present disclosure also relates to a pouch that includes a water-soluble or water-dispersible film that at least partly encapsulates a liquid composition, where the film includes an aversive agent, and where the film is characterized by an average thickness of from 80 um to about 200 um.

The present disclosure also relates to a process of forming a pouch, the process including the steps of: providing a water-soluble or water-dispersible film, where the film includes an aversive agent and is characterized by an average thickness of from 80 um to about 200 um; and at least partly encapsulating a liquid composition with the film.

The present disclosure also relates to a use of a water-soluble or water-dispersible film having an average thickness of from 80 um to about 200 um to reduce migration of an aversive agent in the film when the film encapsulates a liquid composition.

### BRIEF DESCRIPTION OF THE DRAWINGS

FIG. 1 shows a water-soluble film having a thickness T.

FIG. 2 shows a unit dose article.

FIG. 3 shows a cross section of the unit dose article of FIG. 2.

FIG. 4 shows a multi-compartment unit dose article.

### DETAILED DESCRIPTION OF THE INVENTION

It has been surprisingly found that using water-soluble films having an increased thickness can solve one or more problems described above. More specifically, it is believed that water-soluble films having an aversive agent and a thickness of from about 80 μm to about 200 μm, as well as unit dose articles, such as pouches, formed from such films are better able to maintain aversive effects while meeting other processing or performance criteria compared to known 76 μm films.

Without wishing to be bound by theory, it is believed that when pouches are formed from such thicker films and are filled with a liquid composition, the aversive agent found in or on the film migrates from the film to the liquid at a relatively slower rate compared to the migration rate of thinner films. Additionally, when the aversive agent is formulated into the film-forming material, films having a greater thickness provide a greater absolute amount of aversive agent compared to thinner films when the films have similar concentrations on a per-gram basis due to the thicker films having a greater mass for the same surface area.

It is important, however, that the films not be too thick, as such films may be difficult to process or dissolve. For example, detergent pouches made from films having too great a thickness may not completely dissolve in a washing machine, leaving behind an undesirable residue.

In the present disclosure, “thickness” means the distance between two surfaces, for example between a first surface and a second surface, of a solid, such as a film. For a web of film, thickness is typically the dimension having the smallest measure.

The components of the present disclosure are described in more detail below.

### Water-Soluble Film

The present disclosure relates to water-soluble films and unit dose articles comprising such films. The article may be in the form of a pouch. The film may form a compartment and may at least partly encapsulate a composition, for example a liquid composition. The film comprises an aversive agent, described in more detail below.

The water-soluble film may be characterized by an average thickness of from about 80 μm, or even from 80 μm, to about 200 μm. The average thickness of the film may be from about 80 μm, or from about 85 μm, to about 150 μm, or to about 125 μm, or to about 110 μm, or to about 100 μm. The average thickness of the film may be about 85 μm.

It is understood that the thickness of a water-soluble film may change due to processing or converting operations, such as themoforming into a mold or stretching from general film handling. Therefore, as used herein, “thickness” of a film means the thickness before the film has been subjected to any thermoforming, elastic strain, or plasticization techniques. For the removal of doubt, the thickness of the film may be determined prior to the film be formed into a unit dose article and/or a pouch. The average thickness is determined according to the method described below.

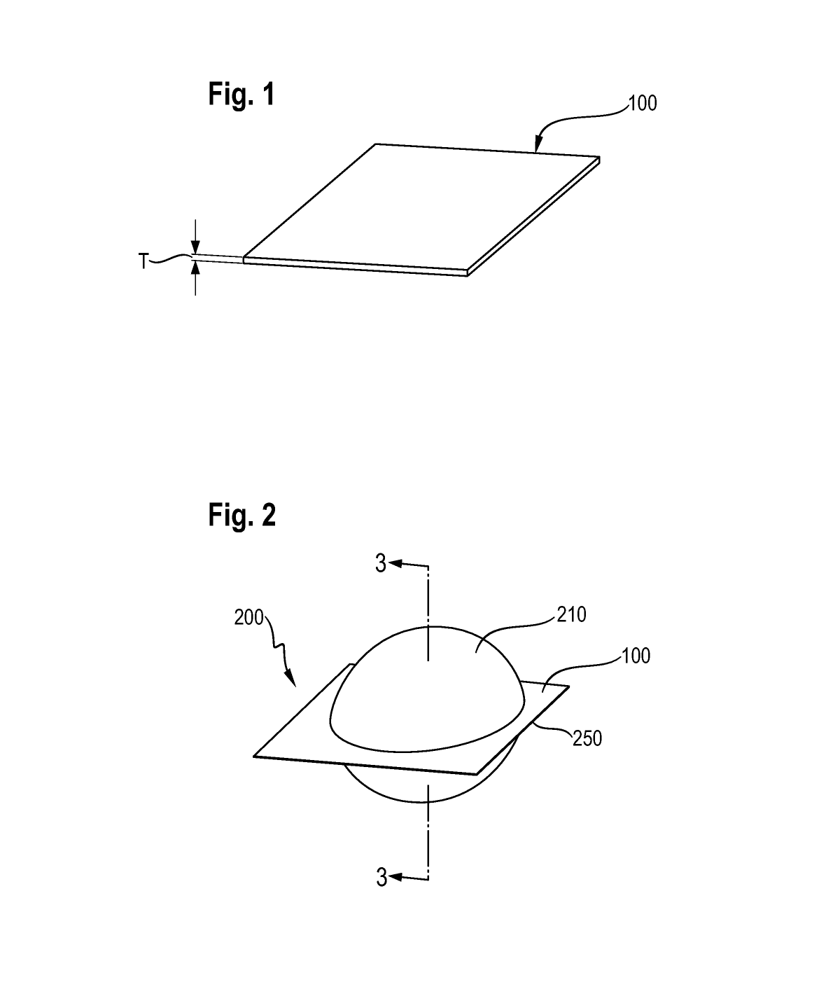

FIG. 1 shows an exemplary water-soluble film 100 of the present disclosure prior to being formed into a pouch. The film 100 has an average thickness T, for example 85 μm.

The film of the present invention is soluble or dispersible in water. Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described below. Water-solubility may be determined at 24° C., or preferably at 10° C.
Dissolution Method: 50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.
   Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.
   Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.
   Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.
   Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material. Preferred films are those supplied by Monosol (Merrillville, Ind., USA) under the trade references M8630, M8900, M8779, M8310, M9467, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray, or the films by Nippon Gohsei, such as Hi Selon. Suitable films include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM. It may be preferable to use a film that exhibits better dissolution than M8630 film, supplied by Monosol, at temperatures 24° C., even more preferably at 10° C.
   Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.
   The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons. Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.
   The films may be water soluble copolymer films comprising a least one negatively modified monomer with the following formula:

[Y]-[G]ₙ

wherein Y represents a vinyl alcohol monomer and G represents a monomer comprising an anionic group and the index n is an integer of from 1 to 3. G can be any suitable comonomer capable of carrying of carrying the anionic group, for example G is a carboxylic acid. G may be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid, and mixtures thereof. Suitable films may include blends of such copolymers.
The anionic group of G may be preferably selected from the group consisting of OSO₃M, SO₃M, CO₂M, OCO₂M, OPO₃M₂, OPO₃HM and OPO₂M. More preferably, the anionic group of G is selected from the group consisting of OSO₃M, SO₃M, CO₂M, and OCO₂M. Most preferably the anionic group of G is selected from the group consisting of SO₃M and CO₂M. As used herein, M is a suitable counterion known to one of ordinary skill, such as hydrogen (H+), an alkali metal (e.g., Na⁺, K⁺), an alkali earth metal (½ Ca²⁺), or ammonium (NH₄⁺).
The film material herein can also comprise one or more additive ingredients. For example, the film preferably comprises a plasticizing agent. The plasticizing agent may comprise water, glycerol, ethylene glycol, diethylene glycol, propylene glycol, diproypylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as solvents found in an encapsulated liquid composition.
Other additives may include water and functional detergent additives, including surfactant, to be delivered to the wash water, for example, organic polymeric dispersants, etc. Additionally, the film may comprise an aversive agent, further described herein.
The water-soluble unit dose article may comprise an area of print. The water-soluble unit dose article may be printed using flexographic techniques, ink jet printing techniques or a mixture thereof. The printed are may be on the film, preferably on the outside of the film, within the film, on the inside of the film or a mixture thereof. The printed area may convey information such as usage instructions, chemical safety instructions or a mixture thereof. Alternatively, the entire surface of the pouch, or substantially the entire surface of the pouch is printed in order to make the pouch opaque. The print may convey an image that reduces the risk of confusion and hence accidental ingestion of the pouch.

### Aversive Agent

The films, unit dose articles, methods, and/or uses of the present disclosure include one or more aversive agents. As used herein, an aversive agent is an agent that is intended to discourage ingestion and/or consumption of the unit dose articles described herein or components thereof, such as water-soluble films. An aversive agent may act by providing an unpleasant sensation, such as an unpleasant taste, when placed in the mouth or ingested. Such unpleasant sensations may include bitterness, pungency (or heat/spiciness), an unpleasant odor, sourness, coldness, and combinations thereof. An aversive agent may also act by causing humans and/or animals to vomit, for example via emetic agents. Suitable aversive agents include bittering agents, pungent agents, emetic agents, and mixtures thereof.

The level of aversive agent used within or on the unit dose articles or components thereof may be at least at an effective level, which causes the desired aversive effect, and may depend on the characteristics of the specific aversive agents, for example bitter value. The level used may also be at or below such a level that does not cause undesired transfer of the aversive agents to a human and/or animal, such as transfer to hands, eyes, skin, or other body parts. The amount present may be based on the particular aversive agent's potency such that greater than 50% of humans experience an aversive effect when exposed to the given amount of the aversive agent. The aversive agent may be present at a concentration which elicits repulsive behavior within a maximum time of six seconds in cases of oral exposure.

The aversive agent may be provided to the unit dose article or component thereof in any suitable manner. The aversive agent may be formulated into a film-forming material during manufacture of the film, or it may be provided after the film is manufactured, or even during or after the manufacture of the unit dose article. If the aversive agent is formulated into the water-soluble film as the film is being manufactured, the water-soluble film may comprise a substrate element and an aversive agent chemically coupled to the substrate element, for example as described in US2014/0371411A1. The aversive agent may be applied to a surface of the unit dose article or component thereof, for example by spraying, printing, atomizing, dusting, powdering, coating, painting, or otherwise depositing the aversive agent directly onto the water-soluble film and/or the finished unit dose article. The aversive agent may be provided in compositions encapsulated by water-soluble film, and may migrate to the film and/or to the surface of the film, which may be facilitated by the selection of certain solvents and/or plasticizers.

When a composition comprising the aversive agent is applied to the film and/or unit dose article, the composition may be non-aqueous so as to minimize dissolution of the film and/or article. Here, by non-aqueous it is meant that the composition may comprise less than about 20%, or less than about 15%, or less than about 10%, or less than about 5%, or less than about 1%, or about 0%, or 0%, by weight of the composition, of water. The composition may comprise up to about 100%, or 80%, or 60%, or 40%, or 35%, or 30% of the aversive agent. The composition may comprise from greater than 0% to about 100%, or from about 0.001% to about 80%, or from about 0.001% to about 60%, or from about 0.001% to about 40%, or from about 0.1% to about 35%, or from about 1% to about 30% by weight of the aversive agent.

The aversive agent may be provided in any suitable form. The aversive agent may be in the form of particles comprising the aversive agent, encapsulates comprising the aversive agent, a gel matrix comprising the aversive agent, or a combination thereof. In such forms, the aversive agent may be held within or on the carrier, within the encapsulate, and/or within the gel matrix until it is contacted with a relevant substrate, such as saliva, after which the aversive agent is released.

The aversive agent may be in the form of particles comprising a carrier and the aversive agent. The carrier may be selected from the group comprising carbonate, sulphate, zeolite, talc, clay, saccharides, polysaccharides, or mixtures thereof. The carrier may comprise a polysaccharide, which may be selected from maltodextrin, cellulose or a mixture thereof.

The carrier may form a matrix into which the aversive agent is absorbed. The aversive agent may be coated onto the carrier. The carrier may form a matrix into which the aversive agent is absorbed and the aversive agent is coated onto the carrier. For example, the aversive agent may be coated onto the carrier and then at least part of the aversive agent is absorbed into the carrier.

Wherein the aversive agent is in the form of a particle, the particle may be a spray-dry particle, an agglomerate, an extrudate, or a mixture thereof.

The aversive agent maybe in the form of a gel matrix comprising the aversive agent. A gel in this case means a composition of sufficiently high viscosity such that it substantially remains adhered to the water-soluble unit dose article until intended use. The gel matrix may comprise a wax, a saccharide, or a mixture thereof.

When the aversive agent is in the form of an encapsulate, the encapsulate may be a core and shell encapsulate, where the core comprises the aversive agent. The shell may comprise polyvinyl alcohol, melamine formaldehyde, polylactide, polyglycolide, gelatin, polyacrylate, shellac, zein, chitosan, wax, hydrogenated vegetable oil, polysaccharides paraffin and mixtures thereof. The shell may comprise a polylactide-polyglycolide copolymer. The shell may comprise a hydrogenated castor oil.

The aversive agent may be selected from the group comprising naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable aversive agents are described in more detail below.

a. Bittering Agents

The aversive agent may comprise a bittering agent. The bittering agent may be present in and/or on the unit dose articles described herein and/or components thereof.

Non-limiting examples of suitable bittering agents include denatonium salts and derivatives thereof. The bittering agent may be a denatonium salt selected from the group consisting of denatonium chloride, denatonium citrate, denatonium saccharide, denatonium carbonate, denatonium acetate, denatonium benzoate, and mixtures thereof. The bittering agent may be denatonium benzoate, also known as phenylmethyl-[2-[(2,6-dimethylphenyl)amino]-2-oxoethyl]-diethylammonium benzoate, CAS no. 3734-33-6. Denatonium benzoate is commercially sold as BITREX®, available from Macfarlan Smith, Edinburgh, Scotland, UK.

The bittering agent may be a natural bitter substance. The natural bitter substance may be selected from the group consisting of glycosides, isoprenoids, alkaloids, amino acids, and mixtures thereof. For example, suitable bittering agents also include Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Prämarrubin; Carnosol; Carnosic acid; Quassin; Brucine; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; and mixtures thereof. Other suitable bittering agents include quinine bisulfate and hop extract (e.g., humulone).

Other non-limiting examples of suitable bittering agents for use as described herein are described at BitterDB (http://bitterdb.agri.huji.ac.il/dbbitter.php), which is a free searchable database of bittering agents that holds over 680 bittering agents obtained from literature and the Merck Index and their associated 25 human bitter taste receptors (hT2Rs), and in the corresponding paper Ayana Wiener; Marina Shudler; Anat Levit; Masha Y. Niv. BitterDB: a database of bitter compounds. Nucleic Acids Res 2012, 40(Database issue):D413-419.

The bittering agent may exhibit a bitter value of greater than 1,000, or greater than 5,000, or greater than 10,000, or greater than 20,000, and/or less than 10,000,000, or less than 5,000,000, or less than 1,000,000, or less than 500,000, or less than 200,000, or less than 150,000, or less than 100,000. The bittering agent may exhibit a bitter value of from about 1,000 to about 10,000,000, or from about 5,000 to about 1,000,000, or from about 10,000 to about 200,000. The bitter value is measured using the standardized process set forth in the European Pharmacopoeia (5th Edition, Stuttgart 2005, Volume 1, General Monograph Groups, 2.8.15 Bitterness Value, p. 278).

The unit dose article or component thereof may comprise a sufficient amount of the bittering agent to provide a bitter taste, for example from about 0.00001% to about 1%, or from about 0.0001% to about 0.5%, or from about 0.001% to about 0.25%, or from about 0.01% to about 0.1% by weight of the unit dose article or component thereof.

The bittering agent may be present at a level of at least 10 ppb, or at least 50 ppb. The bittering agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

b. Pungent Agents

The aversive agent may comprise a pungent agent. Pungent agents provide pungency, which is the characteristic commonly referred to as spiciness, hotness, or “heat,” often found in foods such as chili peppers.

Non-limiting examples of suitable pungent agents may include: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-rnethoxy-4′-hydroxy-phenyl)-1, 3-dioxolane; pepper oil; pepper oleoresin; ginger oleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable pungent agents include polygodial, Tasmannia lanceolata extract, Capsicum extracts, or mixtures thereof. The pungent agent may comprise a capsaicinoid, for example capsaicin, dihydrocapsaicin, nordihydrocapsaicin, homodihydrocapsaicin, homocapsaicin, and/or nonivamide. The pungent agent may comprise capsaicin.

Commercially available suitable pungent agents include OPTAHEAT (Symise Flavors), HOTACT (Lipo Chemicals), and HEATENOL (Sensient Flavors).

The unit dose article and/or component thereof (e.g., water-soluble film) may comprise a sufficient amount of the pungent agent to deliver a pungent taste and/or pungent smell, for example a controlled level of pungency to a user (enough to deter ingestion but not so much as to make a human and/or animal physically ill or to accidentally transfer significant amounts to a user's hands). The article or component thereof may comprise greater than 0.0001%, or greater than 0.001%, or greater than 0.01%, or greater than 0.1%, and/or less than 20%, or less than 15%, or less than 10%, or less than 5%, or less than by 2%, or less than 1%, or less than 0.5%, by weight of the article or component, of the pungent agent. The article or component thereof may comprise from about 0.0001% to about 10%, or from about 0.001% to about 2%, or from about 0.01% to about 1%, or from about 0.1% to about 0.5%, by weight of the article or component, of the pungent agent. The pungent agent may be present at a level of at least 10 ppb, or at least 50 ppb. The pungent agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

The pungency of a pungent agent may be determined according to the well-known Scoville Scale and may be reported in Scoville heat units (SHU). The pungent agent may be selected from pungent agents having a pungency level of at least about 1,000,000 SHU, or at least about 5,000,000 SHU, or at least about 10,000,000 SHU, or at least about 15,000,000 SHU. For comparison, the pungency level of capsaicin is about 16,000,000 SHU. Pungency may also be measured by high performance liquid chromatography and determined in American Spice Trade Association (ASTA) pungency units. A measurement of one part capsaicin per million corresponds to about 15 Scoville units, and ASTA pungency units can be multiplied by 15 and reported as Scoville units.

Because it is desirable that the pungent agent be detectable in order to be an effective aversive agent, it is generally desirable that the pungency not be masked by other agents, such as cooling agents like menthol and the like. Therefore, the unit dose articles and/or components thereof may be free, for example comprising less than 5%, or less than 3%, or less than 1%, or less than 0.1%, or less than 0.01%, or less than 0.001%, or about 0%, or 0%, by weight of the article or component, of cooling agents, for example menthol and/or eucalyptus.

c. Emetic Agents

The aversive agent may comprise an emetic agent. There are two main types of emetic agents: 1) those that work directly on the gastrointestinal tract of humans and animals, and 2) those that work indirectly by stimulating the areas of the brain that control vomiting.

Non-limiting examples of suitable emetic agents that work directly on the gastrointestinal tracts are selected from the group consisting of: ipecac (ipecac syrup and/or ipecac powder) obtained from Cephaelis ipecacuanha, lobelia obtained from Lobelia inflata, mustard seed obtained from Brassica juncea, vomitoxin obtained from Fusarium graminearum, copper sulfate, and mixtures thereof. The aversive agent may comprise ipecac.

An example of an emetic agent that works indirectly by stimulating the areas of the brain that control vomiting is apomorphine (apomorphine hydrochloride).

Water-Soluble Unit Dose Article

The present disclosure relates to a water-soluble unit dose article. The article comprises a water-soluble or water-dispersible film, described in more detail below. The film may at least partially encapsulate a composition, for example a liquid composition, described in more detail below. The composition may be a household care composition.

More specifically, the water-soluble unit dose article may comprise at least one water-soluble film shaped such that the unit-dose article comprises at least one internal compartment surrounded by the water-soluble film. The at least one compartment comprises the detergent or cleaning composition. The water-soluble film is sealed such that the detergent or cleaning composition does not leak out of the compartment during storage. However, upon addition of the water-soluble unit dose article to water, the water-soluble film dissolves and releases the contents of the internal compartment into the wash liquor. When the article, such as a pouch, is placed in water at 20° C., a liquid composition encapsulated therein may be retained within the pouch for at least 30 seconds.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

Each compartment may comprise the same or different compositions. The different compositions could all be in the same form, for example they may all be liquid, or they may be in different forms, for example one or more may be liquid and one or more may be solid. A first compartment may contain a liquid composition, and a second compartment may contain a solid composition, for example a granular or powdered composition. The detergent or cleaning composition may be present in one compartment or may be present in more than one compartment.

The water-soluble unit dose article may comprise an air bubble. The water-soluble unit dose article may be transparent, translucent, opaque, or combinations thereof.

Turning again to the drawings, FIG. 2 shows an exemplary unit dose article 200 according to the present disclosure. The article 200 is in the form of a pouch. The article 200 is formed from a water-soluble film 100, which forms a compartment 210 and a seal region 250. The film 100 has a thickness T of about 100 μm prior to being formed into the pouch, and the film comprises an aversive agent such as BITREX™.

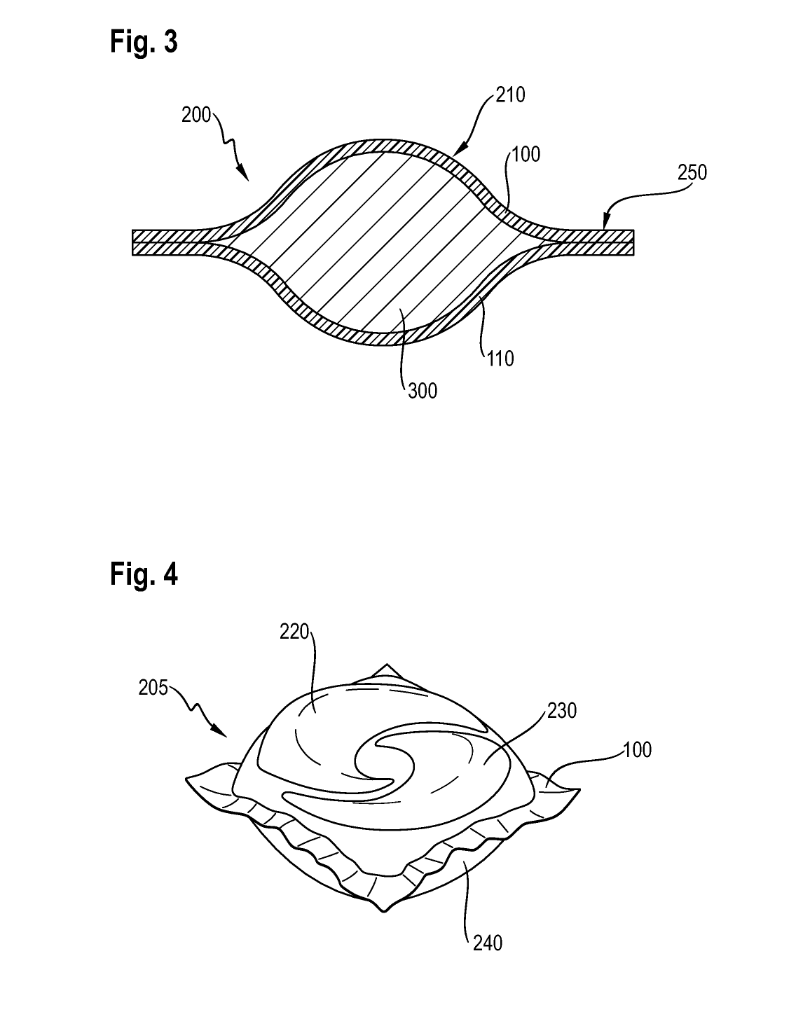

FIG. 3 shows a cross-sectional view of the article 200 of FIG. 3, taken along line 3-3. The article 200 is formed from a first film 100 and a second film 110 that are joined at a seal region 250 to form a single compartment 210. A composition 300, such as a laundry or dish washing detergent composition, resides in the compartment 210, encapsulated by the films 100, 110.

FIG. 4 shows an exemplary multi-compartment unit dose article 205. The article 205 comprises water-soluble film 100 that forms two smaller compartments 220, 230 superposed on a larger bottom compartment 240.

### Composition

The unit dose articles described herein may comprise a composition, such as a detergent or cleaning composition. The unit dose articles may contain a liquid composition. The liquid composition may be at least partially encapsulated by the water-soluble film. By ‘liquid’ we herein mean any composition capable of wetting and treating a substrate and encompasses forms such as dispersions, gels, pastes and the like. A dispersion, for example, is a liquid comprising solid or particulate matter contained therein. The liquid composition may also include gases in suitably subdivided form. At least parts of the composition, e.g., the detergent or cleaning composition, may be in the form of a powder, a compacted powder, a liquid, or a mixture thereof.

The unit dose articles described herein may comprise the detergent or cleaning composition, for example by encapsulating the composition in a water-soluble or water-dispersible film. The detergent or cleaning composition may be a fabric detergent or cleaning composition, an automatic dishwashing detergent or cleaning composition or a mixture thereof.

By “fabric detergent or cleaning composition” we herein mean compositions that provide cleaning benefit to fabrics, care benefit to fabrics or a mixture thereof. The fabric detergent or cleaning composition may provide a cleaning benefit selected from stain removal, stain-repellency, anti-soil-redeposition, brightening, whitening dirt removal, malodour reduction or mixtures thereof. The fabric detergent or cleaning composition may provide a care benefit selected from softening, freshness, anti-wrinkling, anti-colour fading, dye transfer inhibition, anti-static or mixtures thereof.

By “automatic dishwashing detergent or cleaning composition” we herein mean automatic dishwashing compositions that provide cleaning benefits, care benefits or a mixture thereof. “Automatic dishwashing care benefits” refers to any automatic dishwashing composition that can provide shine, fast drying, metal, glass or plastic protection benefits.

The cleaning composition may comprise anionic surfactants, non-ionic surfactants, cationic surfactants, polyethylene glycol polymers, ethoxylated polyethyleneimines, rheology modifier, hueing dyes, perfumes, perfume microcapsules, chelants, enzymes, silicones, polyolefin waxes, latexes, oily sugar derivatives, cationic polysaccharides, polyurethanes, fatty acids, enzyme stabilizing systems; antioxidants, opacifier, pearlescent agent, deposition aid, builder, bleaching agent, bleach activator, bleach catalyst, organic shine polymers, surface modifying polymers, metal care agents, metal salts, anti-corrosion agents and mixtures thereof.

The detergent or cleaning composition may comprise from about 1% to 80% by weight of the detergent or cleaning composition of a surfactant. The surfactant may comprise anionic, nonionic, zwitterionic, ampholytic, zwitterionic, semi-polar, cationic surfactants or mixtures thereof. The surfactant may comprise anionic, nonionic, cationic surfactants and mixtures thereof.

The detergent or cleaning composition may comprise an enzyme. The enzyme may be selected from hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof.

The detergent or cleaning composition may comprise a polymer. The polymer may be selected from carboxylate polymers, polyethylene glycol polymers, terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, ethoxylated polyethyleneimines and any combination thereof.

Other polymers include hydroxyethyl cellulose polymer. Preferably, the hydroxyethyl cellulose polymer is derivatised with trimethyl ammonium substituted epoxide. The cellulose polymer may have a molecular weight of between 100,000 and 800,000 daltons. The hydroxyethyl cellulose polymer may be added to the composition as a particle. It may be present in the composition of the particle or may be also be present as a liquid, or a mixture thereof.

The detergent or cleaning composition may comprise a rheology modifier. The rheology modifier can be selected from the group consisting of non-polymeric crystalline hydroxy-functional materials, polymeric rheology modifiers or mixtures thereof. Specific examples of suitable crystalline, hydroxyl-containing rheology modifiers include castor oil and its derivatives. Also practical are hydrogenated castor oil derivatives such as hydrogenated castor oil and hydrogenated castor wax.

The detergent or cleaning composition may comprise a builder. Suitable builders include polycarboxylate builders include cyclic compounds, particularly alicyclic compounds. Particularly suitable are citrate builders, e.g., citric acid and soluble salts thereof, particularly sodium salts thereof. The builder may be selected from aminocarboxylate builders, preferably selected from salts of MGDA (methyl-glycine-diacetic acid), GLDA (glutamic-N,N-diacetic acid), EDDS (ethylene diamine disuccinates), iminodisuccinic acid (IDS), and carboxymethyl inulin.

The detergent or cleaning composition may comprise a bleaching agent. Bleaching agents may comprise chlorine bleaches, oxygen bleaches, or mixtures thereof. The bleach may be selected from sodium perborate monohydrate, sodium perborate tetrahydrates, sodium percarbonate, and mixtures thereof.

The detergent or cleaning composition may comprise a peroxyacid bleach precursors, preferably selected from precursors of perbenzoic acid, cationic peroxyacid precursors, peracetic acid, sodium acetoxybenzene sulfonate, pentaacetylglucose, sodium 3,5,5-trimethylhexanoyloxybenzene sulfonate (iso-NOBS), sodium nonanoyloxybenzene sulfonate (NOBS), amide substituted alkyl peroxyacid precursors, benzoxazin peroxyacid precursors and mixtures thereof. The bleach may comprise ε-phthalimidoperoxycaproic acid[phthaloiminoperoxyhexanoic acid (PAP).

Preferably, if the detergent or cleaning composition comprises an automatic dish washing composition, the automatic dishwashing composition is phosphate free, or substantially phosphate free.

The detergent or cleaning composition may comprise a hueing dye, a brightener or a mixture thereof.

Preferably the detergent or cleaning composition comprises a non-aqueous solvent, preferably between 5% and 30%, more preferably between 7% and 25% by weight of the detergent or cleaning composition of a non-aqueous solvent. Preferably, the non-aqueous solvent is selected from glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

The detergent or cleaning composition may comprise water, preferably from 0.1% to 20%, more preferably from 0.5% to 15%, most preferably from 1% to 13.5% by weight of the detergent or cleaning composition of water.

### Process for Making

The present disclosure further relates to a process of forming a pouch from a water-soluble or water-dispersible film and at least partially encapsulating a liquid composition with the film to form a unit dose article.

Suitable films are described above. The film may be characterized by an average thickness of from about 80 μm to about 200 μm, or from about 85 um to about 125 um, from about 90 um to about 110 um, or even about 100 um. The method for determining the average thickness of the film is provided below.

The film may comprise an aversive agent. Suitable aversive agents are described above. The aversive agent may be selected from a bittering agent, a pungent agent, an emetic agent, or a combination thereof. Suitable aversive agents include bittering agents, such as a denatonium salt or a derivative thereof. The aversive agent may comprise denatonium benzoate (BITREX™).

The aversive agent may be directly formulated into the film. The aversive agent may be provided to the film prior to pouch formation, or the aversive agent may be provided to the finished unit dose article. The aversive agent may be applied to a surface of the unit dose article or component thereof, for example by spraying, printing, atomizing, dusting, powdering, coating, painting, or otherwise depositing the aversive agent directly onto the water-soluble film and/or the finished unit dose article.

The process of forming unit doses article is described in more detail below.

The process of the present disclosure may be continuous or intermittent. The process comprises the general steps of forming an open pouch, preferably by forming a water-soluble film into a mould to form said open pouch, filling the open pouch with a composition, preferably the liquid composition, closing the open pouch filled with a composition, preferably using a second water-soluble film to form the unit dose article. The second film may also comprise compartments, which may or may not comprise compositions. Alternatively, the second film may be a second closed pouch containing one or more compartments, used to close the open pouch. Preferably, the process is one in which a web of unit dose article are made, said web is then cut to form individual unit dose articles.

Alternatively, the first film may be formed into an open pouch comprising more than one compartment. In which case, the compartments formed from the first pouch may are in a side-by-side or ‘tire and rim’ orientation. The second film may also comprise compartments, which may or may not comprise compositions. Alternatively, the second film may be a second closed pouch used to close the multicompartment open pouch.

The unit dose article may be made by thermoforming, vacuum-forming or a combination thereof. Unit dose articles may be sealed using any sealing method known in the art. Suitable sealing methods may include heat sealing, solvent sealing, pressure sealing, ultrasonic sealing, pressure sealing, laser sealing or a combination thereof.

The unit dose articles may be dusted with a dusting agent. Dusting agents can include talc, silica, zeolite, carbonate or mixtures thereof.

An exemplary means of making the unit dose article of the present invention is a continuous process for making an article according to any preceding claims, comprising the steps of:

a. continuously feeding a first water-soluble film onto a horizontal portion of an continuously and rotatably moving endless surface, which comprises a plurality of moulds, or onto a non-horizontal portion thereof and continuously moving the film to said horizontal portion;
b. forming from the film on the horizontal portion of the continuously moving surface, and in the moulds on the surface, a continuously moving, horizontally positioned web of open pouches;
c. filling the continuously moving, horizontally positioned web of open pouches with a product, to obtain a horizontally positioned web of open, filled pouches;
d. preferably continuously, closing the web of open pouches, to obtain closed pouches, preferably by feeding a second water-soluble film onto the horizontally positioned web of open, filed pouches, to obtain closed pouches; and
e. optionally sealing the closed pouches to obtain a web of closed pouches.

The second water-soluble film may comprise at least one open or closed compartment. The first film, the second film, or both may comprise the aversive agent. The first film, the second film, or both may have thicknesses that are the same, or the thicknesses may be different.

A first web of open pouches may be combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

The resultant web of closed pouches may be cut to produce individual unit dose articles.

### Use of Film

The present disclosure further relates to a use of a water-soluble or water-dispersible film having an average thickness of from 80 μm to about 200 μm to reduce migration of an aversive agent in a unit dose article when the film encapsulates a liquid composition. Suitable films are described above. The film may be characterized by an average thickness of from about 85 um to about 125 um, from about 90 um to about 110 um, or even about 100 um. The method for determining the average thickness of the film is provided below.

### Method of Use

The present invention is also to a method of doing laundry comprising the steps of diluting a water-soluble unit dose article according to the present invention in water by a factor of at least 400 to form a wash liquor and then washing fabrics with said wash liquor.

The unit dose article of the present invention may be used alone in the wash operation or may be used in conjunction with other laundry additives such as fabric softeners (such as the commercially available DOWNY) or fabric stain removers. The unit dose article may be used in conjunction with fragrance boosting compositions such as commercially available LENOR UNSTOPABLES.

### Methods

### Method for Determining Average Film Thickness

Preferably, film thickness is measured according to ASTM D6988-13.

Alternatively, film thickness is measured according to the following method. Thickness testing is performed on a Thwing-Albert (West Berlin, N.J., USA), Model 89-100, thickness tester machine.

The PVA film may be prepared by storing the film at 22° C. (+/−3° C.) and at 45% Relative Humidity (+/−5%) for at least 24 hours prior to testing. Gloves are used to handle the film; there should be minimal handling, and creases and tears should be avoided. A piece of film, 100 mm×100 mm if possible, should be cut and prepared. A marker is used to lightly mark multiple dots that are equally spaced (approx. 10 mm apart and off-set, if possible) on the film. For example, 25 and/or 46 spots may be marked.

The thickness testing machine is turned on, warmed up, and prepared for measurements according to the manufacturer's instructions. The film sample is placed between the base of the equipment and the sensing probe (anvil). The first spot to be measured is placed in the middle of the metal base so that it is able to be targeted with the anvil. The Test button is pressed, and the anvil lowers. When the test is complete, note the thickness. Position and measure the second spot, and subsequent spots, accordingly, noting the thicknesses for each. After all the measurements have been taken, the statistics button may be used to determine the average thickness for the sample. Prior to measuring a second film sample, the machine should be cleared to reset the machine's memory.

### Method for Measuring Presence/Migration of Aversive Agent

To determine the presence and/or amount of aversive agent present on the surface of the film, sensory or analytical techniques may be employed. A suitable sensory technique (e.g., via taste in controlled circumstances) is disclosed in WO2014/026855 A1, assigned to Henkel AG & Co.

The aversive agent may be extracted from the surface via the following method. The unit dose pouch is held with tweezers at the seal. The surface of the each side of the pouch is rinsed 10 times, with 4 to 5 mL of methanol used in each rinse cycle and collected. After rinsing, the methanol solution is transferred to a glass vial, and the methanol is evaporated. The remaining extract is then dissolved in the appropriate solvent needed for the analytical method.

Aversive agents can be assayed via standard methods known to those skilled in the art. Analytical techniques may include chromatography or spectroscopic techniques known to one skilled in the art. For example, suitable methods are disclosed in Falkner et al., Journal of Chromatography A. 715 (1995) 189-194, and in R. Bucci et al., Talanta 68 (2006) 781-790.

### EXAMPLES

Compositions according to the following formulations are encapsulated in pouches formed from water-soluble film, where the film is characterized by an average thickness of about 100 μm as determined according to the method herein, and where the film includes an aversive agent (denatonium benzoate, sold under the tradename BITREX™, available from MacFarlan Smith, Edinburgh, Scotland). The compositions in the compartments of examples 1.1 and 1.3 are liquid. In example 1.2, the composition in compartment #1 is a solid, and the composition in compartment #2 is a liquid.

TABLE 1

| | 1.1 | | | 1.2 | | 1.3 | | |
|---|---|---|---|---|---|---|---|---|
| | 3 compartments | | | 2 compartments | | 3 compartments | | |
| Compartment # | 1 | 2 | 3 | 1 | 2 | 1 | 2 | 3 |
| Dosage (g) | 34.0 | 3.5 | 3.5 | 30.0 | 5.0 | 25.0 | 1.5 | 4.0 |
| Ingredients | Weight % | | | | | | | |
| Alkylbenzene sulfonic acid | 20.0 | 20.0 | 20.0 | 10.0 | 20.0 | 20.0 | | |
| Alkyl sulfate | | | | 2.0 | | | | |
| C12-14 alkyl 7-ethoxylate | 17.0 | 17.0 | 17.0 | | 17.0 | 17.0 | | |
| Cationic surfactant | | | | 1.0 | | | | |
| Zeolite A | | | | 10.0 | | | | |
| C12-18 Fatty acid | 13.0 | 13.0 | 13.0 | | 18.0 | 18.0 | | |
| Sodium acetate | | | | 4.0 | | | | |
| Enzymes | 0-3 | 0-3 | 0-3 | 0-3 | | 0-3 | | |
| Sodium Percarbonate | | | | 11.0 | | | | |
| TAED | | | | 4.0 | | | | |
| Organic catalyst¹ | | | | 1.0 | | | | |
| PAP granule² | | | | | | | | 50 |
| Polycarboxylate | | | | 1.0 | | | | |
| Ethoxysulfated | 2.2 | 2.2 | 2.2 | | | | | |
| Hexamethylene Diamine | | | | | | | | |
| Dimethyl Quat | | | | | | | | |
| Hydroxyethane | 0.6 | 0.6 | 0.6 | 0.5 | | | | |
| diphosphonic acid | | | | | | | | |
| Ethylene diamine | | | | | | 0.4 | | |
| tetra(methylene phosphonic) | | | | | | | | |
| acid | | | | | | | | |
| Brightener | 0.2 | 0.2 | 0.2 | 0.3 | | 0.3 | | |
| Alkoxylated polyamine⁶ | 5 | | | | 4 | 7 | | |
| Hueing dye⁴ | | | 0.05 | | 0.035 | | 0.12 | |
| Perfume | 1.7 | 1.7 | | 0.6 | | 1.5 | | |
| Water | 10.0 | 10.0 | 10.0 | | 4.0 | | | |
| Glycerol | 5 | | | | | 6 | 10 | |
| Sorbitol | | | | | 1 | | | |
| Propane diol | 5 | 5 | 5 | | 30 | 11 | 89 | |

| | |
|---|---|
| Buffers (sodium | To pH 8.0 for liquids |
| carbonate, | To RA > 5.0 for powders |
| monoethanolamine)⁵ | |
| Minors (antioxidant, | To 100% |
| aesthetics, . . . ), sodium | |
| sulfate for powders | |

¹Sulfuric acid mono-[2-(3,4-dihydro-isoquinolin-2-yl)-1-(2-ethyl-hexyloxymethyl)-ethyl] ester as described in U.S. Pat No. 7,169,744
²PAP = Phthaloyl-Amino-Peroxycaproic acid, as a 70% active wet cake
³Polyethylenimine (MW = 600) with 20 ethoxylate groups per —NH.
⁴Ethoxylated thiophene, EO (R₁ + R₂) = 5
⁵RA = Reserve Alkalinity (g NaOH/dose)
⁶PEI600 EO20, available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pouch comprising a water-soluble or water-dispersible film that at least partly encapsulates a liquid composition,
wherein the film comprises an aversive agent, and
wherein the film is characterized by an average thickness of from 80 um to about 200 um.

2. A pouch according to claim 1, wherein the average thickness of the film is from 80 um to about 150 um, preferably from 85 um to about 125 um, more preferably from 85 um to 100 um, even more preferably about 85 um.

3. A pouch according to claim 1, wherein the aversive agent is selected from a bittering agent, a pungent agent, an emetic agent, or a combination thereof.

4. A pouch according to claim 1, wherein the aversive agent is selected from the group consisting of naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-rnethoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

5. A pouch according to claim 1, wherein the aversive agent is a bittering agent comprising a denatonium salt or a derivative thereof.

6. A pouch according to claim 5, wherein the bittering agent comprises denatonium benzoate.

7. A pouch according to claim 1, wherein the aversive agent is formulated into the water-soluble film.

8. A pouch according to claim 1, wherein the aversive agent is a bittering agent present in an amount of from about 10 ppb to about 10,000 ppm, as determined after storage of the article and/or film for one month 25° C. and 60% relative humidity.

9. A pouch according to claim 1, wherein the liquid composition comprises a household treatment composition selected from a fabric care composition, a dish washing composition, and mixtures thereof.

10. A pouch according to claim 1, wherein the liquid composition comprises anionic surfactant.

11. A pouch according to claim 1, wherein the pouch comprises at least two compartments, preferably at least three compartments.

12. A pouch according to claim 11, wherein a first compartment contains the liquid composition, and wherein a second compartment contains a solid composition, preferably a granular or powdered composition.

13. A pouch according to claim 1, wherein the film comprises a polyvinyl alcohol polymer.

14. A pouch according to claim 1, wherein when the pouch is placed in water at 20° C., the liquid composition is retained within the pouch for at least 30 seconds.

15. A process of forming a pouch, the process comprising the steps of:
providing a water-soluble or water-dispersible film,
wherein the film comprises an aversive agent, and
wherein the film is characterized by an average thickness of from 80 um to about 200 um; and
at least partly encapsulating a liquid composition with the film.

16. A process according to claim 15, wherein the average thickness of the film is from 80 um to about 150 um, preferably from 85 um to about 125 um, more preferably from 85 um to 110 um, even more preferably about 85 um.

17. A process according to claim 15, wherein the aversive agent is selected from a bittering agent, a pungent agent, an emetic agent, or a combination thereof.

18. A process according to claim 15, wherein the aversive agent comprises a bittering agent.

19. A water-soluble or water-dispersible film,
wherein the film comprises an aversive agent, and
wherein the film is characterized by an average thickness of from 80 um to about 200 um.

20. A use of a water-soluble or water-dispersible film having an average thickness of from 80 um to about 200 um to reduce migration of an aversive agent in the film when the film encapsulates a liquid composition.
